(19) United States
(12) Patent Application Publication
(10) Pub. No.: US 2025/0003090 A1
(43) Pub. Date: Jan. 2, 2025

(54) COPOLYMER-BASED ENCAPSULATION FOR DURABLE CATALYST PARTICLES

(71) Applicant: Robert Bosch GmbH, Stuttgart (DE)

(72) Inventors: Karim GADELRAB, Boston, MA (US); Mordechai KORNBLUTH, Brighton, MA (US); DANIIL A KITCHAEV, Brookline, MA (US); Christina JOHNSTON, Spanish Fort, AL (US)

(21) Appl. No.: 18/214,703

(22) Filed: Jun. 27, 2023

(51) Int. Cl. C25B 11/081; C25B 11/089

(52) U.S. Cl. CPC C25B 11/081; C25B 11/089

(57) ABSTRACT

An electrochemical cell includes first and second electrodes. The first electrode includes first catalyst particles enhancing activity in the electrochemical cell. The second electrode including second catalyst particles enhancing activity in the electrochemical cell. One or both of the first and second catalyst particles are at least partially encapsulated in a silica encapsulation formed from a precursor of a silicon-based copolymer. The silica encapsulation sustains the activity of the first and/or second catalyst particles.

### TECHNICAL FIELD

The present disclosure relates to a copolymer-based encapsulation for durable catalyst particles for use in electrochemical cells. The copolymer material used in the copolymer may be a silicon-based copolymer material. The catalyst particles may be catalyst nanoparticles.

### BACKGROUND

With growing interest in green technologies worldwide, electrochemical cells such as fuel cells and electrolyzers are interesting candidates for various applications. An electrochemical cell is a device capable of either generating electrical energy from chemical reactions (e.g., fuel cells) or using electrical energy to conduct electrochemical reactions (e.g., electrolyzers).

Fuel cells have shown promise as an alternative power source for vehicles and other transportation applications. Fuel cells operate with a renewable energy carrier, such as hydrogen. Hydrogen fuel cells also operate without toxic emissions or greenhouse gases. An individual fuel cell includes a membrane electrode assembly (MEA) and two flow field plates. An individual fuel cell typically delivers 0.5V to 1.0V. Individual fuel cells may be stacked together to form a fuel cell stack having higher voltage and power. One type of fuel cell is a proton exchange membrane fuel cell (PEMFC).

Electrolyzers undergo an electrolysis process to split water into hydrogen and oxygen, providing a promising method for hydrogen generation from renewable resources. An electrolyzer, like a fuel cell, includes anode and cathode catalyst layers separated by an electrolyte membrane. The electrolyte membrane may be an ion-conducting polymer, an alkaline solution, or a solid ceramic material. A catalyst material is included in the anode and cathode catalyst layers of the electrolyzer. One type of electrolysis cell is a proton exchange membrane electrolysis cell (PEMEC).

One of the main technical challenges of achieving long durability and low cost of electrochemical cells is catalyst degradation. The dissolution of the catalyst material may lead to a loss in the electrochemical active surface area (ECSA). In PEMFCs, this loss in ECSA leads to a subsequent reduction in the activity of the oxygen reduction reaction (ORR). Migration ions may activate other modes of degradation in the ionomer and the membrane of the electrochemical cell.

### SUMMARY

In one embodiment, an electrochemical cell is disclosed. The electrochemical cell includes first and second electrodes. The first electrode includes first catalyst particles enhancing activity in the electrochemical cell. The second electrode including second catalyst particles enhancing activity in the electrochemical cell. One or both of the first and second catalyst particles are at least partially encapsulated in a silica encapsulation formed from a precursor of a silicon-based copolymer. The silica encapsulation sustains the activity of the first and/or second catalyst particles.

In another embodiment, an encapsulated catalyst particle system for an electrochemical cell is disclosed. The encapsulated catalyst particle system includes catalyst particles configured to enhance activity in the electrochemical cell. The encapsulated catalyst particle system further includes an encapsulation precursor of a silicon-based copolymer at least partially encapsulating the catalyst particles. The encapsulation precursor is configured to sustain the activity of the catalyst particles.

In yet another embodiment, a method of forming encapsulated catalyst particles for an electrochemical cell is disclosed. The method includes applying an encapsulation precursor of a silicon-based copolymer to catalyst particles. The catalyst particles are configured to enhance activity in the electrochemical cell. The method further includes subjecting the encapsulation precursor to an oxygen treatment to obtain the encapsulated catalyst particles including a silica encapsulation.

### BRIEF DESCRIPTION OF THE DRAWINGS

FIG. 1A depicts a schematic side view of a fuel cell according to one embodiment.

FIG. 1B depicts a schematic side view of an electrolyzer according to an embodiment.

FIG. 2 is a schematic diagram of the steps to form an encapsulated catalyst nanoparticle system from a catalyst nanoparticle and a silicon-based copolymer.

FIG. 3A is a schematic view of an encapsulation catalyst nanoparticle system with a relatively higher carbon thickness on the surface of platinum catalyst nanoparticles after a relatively shorter oxygen treatment according to one embodiment.

FIG. 3B is a schematic view of an encapsulation catalyst nanoparticle system with a relatively lower carbon thickness on the surface of platinum catalyst nanoparticles after a relatively longer oxygen treatment according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. These terms may be used to modify any numeric value disclosed or claimed herein. Generally, the term “about” denoting a certain value is intended to denote a range within ±5% of the value. As one example, the phrase “about 100” denotes a range of 100±5, i.e., the range from 95 to 105. Generally, when the term “about” is used, it can be expected that similar results or effects according to the invention can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1 to 10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A”, the term also covers the possibility that B is absent, i.e., “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Electrochemical cells provide an attractive solution for clean energy generation. One non-limiting example of an electrochemical cell is a proton exchange membrane fuel cell (PEMFC). Running on hydrogen as a fuel, PEMFCs have many potential benefits (e.g., high efficiency, rapid start-up, and high-power density). Major strides have been made in improving PEMFC technology by optimizing internal cell design, reducing catalyst loading, and increasing power density. Notwithstanding, the durability of PEMFC components (e.g., the catalysts) remains a challenge to overcome to achieve large scale deployment of PEMFC technology.

While platinum nanoparticles and their alloys may be used to catalyze the sluggish oxygen reduction reaction (ORR) at the cathode of the PEMFC, the highly acidic environment induces accelerated platinum nanoparticle dissolution during potential cycling and startup and shutdown scenarios. The dissolution of platinum nanoparticles leads to a loss in electrochemical active surface area (ECSA), causing a subsequent reduction in ORR activity. Furthermore, the generated platinum ions may disperse in the ionomer and the membrane and redeposit either at an interface between the electrode and the membrane or inside the membrane, which may increase the probability of hydrogen peroxide production, and potentially accelerate degradation of the polymeric matter in the PEMFC. These scenarios are becoming more significant given the demand of reducing platinum cathode loading because of cost considerations.

One proposal to improve catalyst stability in a PEMFC includes encapsulating a catalyst material with an encapsulation. The encapsulation may be an overlayer deposited on a surface of a catalyst particle (e.g., a nanoparticle) formed of a catalyst material. The overlayer may have an ultrathin thickness and/or may be formed of a semipermeable material. The overlayer may be configured to resist loss of the catalyst material while allowing reactive species to reach the catalyst surface.

Silica (SiOₓ) is a candidate for an encapsulation material. A consideration in the performance of a silica encapsulation material is composition. Changing the siloxane precursor composition or composite structure of the silicon oxide encapsulation alters its physical and chemical properties, which may subsequently influence the performance of silica encapsulated platinum electrodes.

One proposal employs carbon modified silica on flat platinum (Pt) slabs to study the influence of an encapsulation composition on the transport of gaseous species and electrochemical properties of platinum (Pt). This proposal finds opposing trends in proton and O₂ permeability as a function of catalyst encapsulation. H⁺ transport may be enhanced at longer cure times. These longer cure times promote the formation of a dense, uniform catalyst encapsulation containing a continuous SiOₓ network that is well suited for promoting H⁺ hopping along Si—O moieties. In contrast, using this proposal, oxygen permeability is largest for catalyst encapsulation exposed to shorter cure times, which were characterized by lower densities that can promote O₂ diffusion through larger free volume regions.

Considering the foregoing, what is needed is a catalyst encapsulation providing precise control over the composition and/or thickness of the encapsulating materials. What is further needed are encapsulating materials that are applicable to different types of electrochemical cells such as electrochemical cells and electrolyzers. One or more embodiments provide such encapsulated catalyst particle systems.

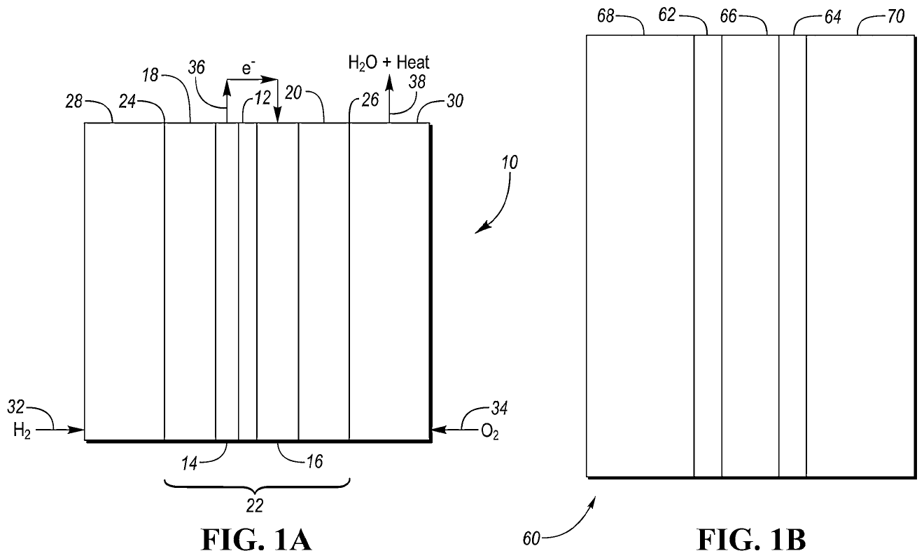

FIG. 1A depicts a schematic side view of fuel cell 10 according to one embodiment. The catalyst encapsulations of one or more embodiments may be applied to fuel cell 10. Fuel cell 10 may be stacked to create a fuel cell stack. Fuel cell 10 includes polymer electrolyte membrane (PEM) 12, anode 14, cathode 16 and first and second gas diffusion layers (GDLs) 18 and 20. PEM 12 is situated between anode 14 and cathode 16. Anode 14 is situated between first GDL 18 and PEM 12 and cathode 16 is situated between second GDL 20 and PEM 12. PEM 12, anode 14, cathode 16 and first and second GDLs 18 and 20 comprise membrane electrode assembly (MEA) 22. First and second sides 24 and 26 of MEA 22 is bounded by flow fields 28 and 30, respectively. Flow field 28 supplies H₂ to MEA 22, as signified by arrow 32. Flow field 30 supplies O₂ to MEA 22, as signified by arrow 34. One or more catalyst materials are used in anode 14 and cathode 16. Non-limiting examples of catalyst materials include platinum, palladium, ruthenium, an alloy thereof, and a combination thereof.

FIG. 1B depicts a schematic side view of electrolyzer 60 according to an embodiment. Electrolyzers undergo an electrolysis process to split water into hydrogen and oxygen. Electrolyzer 60 includes anode catalyst layer 62 and cathode catalyst layer 64 separated by electrolyte membrane 66. A catalyst material is included in anode catalyst layer 62 and cathode catalyst layer 64. Electrolyte membrane 66 may be a polymer, an alkaline solution, or a solid ceramic material. Porous transport layer 68 contacts the surface of anode catalyst layer 62 opposing electrolyte membrane. Gas diffusion media 70 contacts the surface of cathode catalyst layer 64 opposing electrolyte membrane 66. An oxygen evolution reaction (OER) occurs at anode catalyst layer 62 and a hydrogen evolution reaction (HER) occurs at cathode catalyst layer 64 with H⁺ ions flowing across electrolyte membrane 66 from anode catalyst layer 62 to cathode catalyst layer 64.

While FIGS. 1A and 1B depict a PEMFC and an electrolyzer, respectively, one or more embodiments of the catalyst encapsulations may be applied to any type of electrochemical cell or system (e.g., an alkaline anion exchange membrane fuel cell or a carbon dioxide electrochemical conversion device).

In one or more embodiments, catalyst encapsulations for electrochemical systems (e.g., fuel cells and electrolyzers) are disclosed. The encapsulation may be based on a silicon-carbon copolymer. The sequence, chain length, and/or proportions of silicon monomers and carbon monomers in the silicon-carbon copolymer may be tailored to achieve an encapsulation for different applications. The application process and the encapsulation material may be applied to any metallic nanoparticles suitable as a catalyst material in an electrode of an electrochemical cell (e.g., a fuel cell or an electrolyzer).

The catalyst encapsulations may have one or more benefits. The catalyst encapsulation may achieve high reactivity, long durability and stability by resisting dissolution, minimal catalyst poisoning with ionomer or carbon monoxide, and/or selectivity by blocking undesirable reactions. In one or more embodiments, a carbon-doped silica film may be applied to the surfaces of catalyst particles using a silicon-based copolymer as a precursor. According to one method, a variety of silicon carbon-based copolymers are suitable to be dissolved in organic solvents and mixed with supported catalyst nanoparticles then treated with oxygen (e.g., through a ultraviolet (UV) treatment or a plasma treatment) to produce a permanent silica encapsulation with an engineered chemistry. Such control over composition and treatment time may be leveraged to achieve enhanced permeability of reactants to catalyst surface.

The monomer units of the silicon-based copolymer may be arranged in different patterns (e.g., linear, branched, comb, and/or brush patterns). The copolymer structure may be a block copolymer, a random copolymer, or an alternating copolymer. In the block copolymer, different blocks of monomers may have different chemical and/or physical properties that govern the properties of the silicon-based copolymer material. The silicon-based copolymer material may be applied to a catalyst material (e.g., catalyst particles) to form a coating layer at least partially or entirely surrounding the catalyst material. The catalyst particles may be catalyst nanoparticles. After applications of the silicon-based copolymer material to the catalyst material, the silicon-based copolymer material may be cured (e.g., treated with oxygen) to produce a permeable and durable coating of silica (e.g., carbon doped silica) configured to enhance catalyst durability and to resist catalyst dissolution.

The silicon-based copolymer material may be comprised of one or more chains containing two or more chemistries with different arrangement. The silicon-based copolymer material may be a linear diblock copolymer including a first block of a first number of first monomers bonded in a first polymeric chain and a second number of second monomers bonded in a second polymeric chain where the first and second blocks are bonded to each other to form the linear copolymer diblock copolymer. The first and second monomers may have chemical dissimilarities to produce local ordering and/or segregation of the linear deblock copolymer. Certain chemistries within the silicon-based copolymer material may migrate to a free surface or an interface due to thermodynamic forces. These chemistries are selected as coatings and for functionalization. Silicon-based copolymer materials are selected as catalyst encapsulations in one or more embodiments to encapsulate catalyst nanoparticles. The silicon-based copolymer material may include silicon-based and carbon-based monomers to promote microphase separation because of a relatively large degree of incompatibility between the silicon-based and carbon-based monomers.

The silicon-based copolymer material may be a low molecular weight copolymer. The molecular weight copolymer may be any of the following values or in a range of any two of the following values: 5,000, 6,000, 7,000, 8,000, 9,000, 10,000, 11,000, 12,000, 13,000, 14,000, 15,000, 16,000, 17,000, 18,000, 19,000, and 20,000 Daltons. A low molecular weight copolymer may be applied to catalyst nanoparticles using a spin coating technique. For instance, the silicon-based copolymer material may be dissolved in an organic solvent (e.g., toluene, heptane, or a combination thereof). After the silicon-based copolymer is dissolved in the organic solvent, the catalyst nanoparticles are added to the organic solvent and mixed. In one or more embodiments, the mixture is dispersed. The dispersion may be achieved using spin coating or sonication.

The structure of the catalyst particle (e.g., catalyst nanoparticle) and encapsulation system may be adjusted using one or more annealing methods. For instance, the polymer chains within the silicon-based copolymer may reorient and align to a relaxed state surrounding the catalyst nanoparticle. This type of annealing process may be carried out using solvent vapor annealing or thermal annealing. During the annealing step, the silicon-based monomers in the silicon-based copolymer tending migrate to a surface region given their relatively low surface energy. The annealing time may be tuned to define the extent of phase separation between a first chemistry (e.g., one or more silicon-based monomers) and a second chemistry (e.g., one or more carbon-based monomers).

The adjusted structure of the catalyst particle (e.g., catalyst nanoparticle) and encapsulation system is cured according to one or more embodiments. Non-limiting examples of curing steps include UV exposure or oxygen plasma exposure. The curing step may be used to remove the carbon-based matter from the system (e.g., through ashing), while the silicon-based monomers are transformed into durable silica. By tuning the extent of exposure, control over the silica structure, and/or density, carbon doping may be achieved.

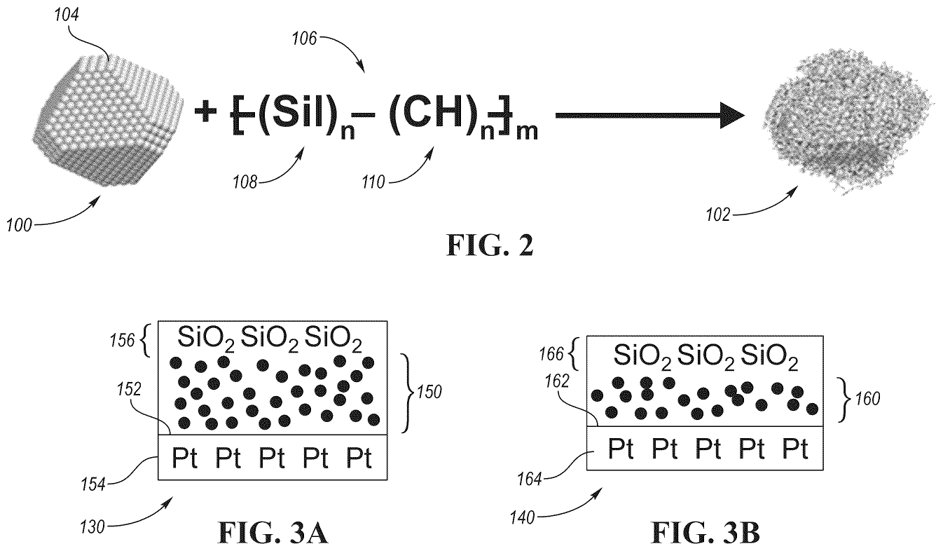

FIG. 2 is a schematic diagram of steps 100 to form encapsulated catalyst nanoparticle system 102 from catalyst nanoparticle 104 and silicon-based copolymer 106. As shown in FIG. 2, silicon-based copolymer 106 includes silicon-based monomer units 108 (i.e., Sil as depicted on FIG. 2) and carbon-based monomer units 110 (i.e., CH as depicted on FIG. 2).

The number n of bonded silicon-based monomer units 108 and carbon-based monomer units 110 may be independently selected from any of the following values or in a range of any two of the following values: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200. The arrangement of silicon-based monomer units 108 and carbon-based monomer units 110 within the brackets may be repeated m number of times. The number m may be any of the following values or in a range of any two of the following values: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200.

Silicon-based monomer units 108 may include monomer units including one or more siloxane groups, one or more carbosiloxane groups, one or more silane groups, one or more carbosilane groups, and combinations thereof. Equations (1), (2), and (3) below depict examples of polysiloxane, polycarbosiloxane, and polycarbosilane groups, respectively. The value of n may be any of the following values or in a range of any two of the following values: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200.

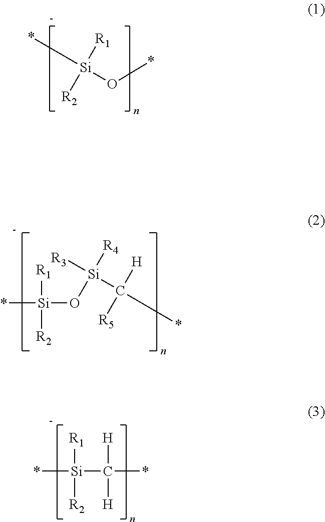

Carbon-based monomer units 110 may include monomer units including one or more styrene groups, one or more ethylene groups, one or more propylene groups, or combinations thereof. Other carbon-based groups may include hydrocarbon functional groups such as alkanes, alkenes, alkynes and arenes.

In one or more embodiments, a metallic nanoparticle formed of a catalyst material is coated with the silicon-based copolymer, which contains both one or more silicon-based monomer units and one or more carbon-based units. The catalyst material may be pure Pt, a Pt-M alloy (where M is another metal from the periodic table), other platinum group members (PGM) metals (e.g., Ru, Rh, Pd, Os, and/or Ir), a PGM-M alloy (where M is another metal from the periodic table), a Pt-PGM-M alloy (where M is another metal from the periodic table), or a combination thereof.

After the coating step, the coated nanoparticle is subjected to an oxygen treatment to form an encapsulated catalyst nanoparticle. The oxygen treatment may be applied by UV light and/or plasma treatment. The treatment step may create a thin membrane around the catalyst nanoparticle. The thickness of the thin membrane may be any of the following values or in a range of two of the following values: 1.0, 1.5, 2.0, 2.5, 3.0, 3.5, 4.0, 4.5, and 5.0 nanometers.

The final structure and composition of the encapsulated coating (e.g., density) may be controlled by the duration of the oxygen treatment. A relatively longer treatment time (e.g., curing time) may ash away carbon content in the encapsulation coating or film and produce a dense silica film configured to promote proton diffusion but resist O₂ transport. A relatively shorter treatment time (e.g., curing time) may maintain a higher carbon concentration in the encapsulation coating or film with a loosely connected silica network. In one or more embodiments, the loosely connected silica network is permeable to O₂ but offers nonideal proton hoping characteristics. Polymer chemistry, molecular weight, annealing time, and/or post treatment time are degrees of freedom to adjust the performance characteristics of the encapsulated coating or film. For an encapsulation coating formed by a silicon-based copolymer material, the process may be applied to catalyst nanoparticles that are connected to an electrically conductive support to maintain electrochemical activity.

FIG. 3A is a schematic view of encapsulation catalyst nanoparticle system 130 with relatively higher carbon thickness 150 on surface 152 of platinum catalyst nanoparticles 154 after a relatively shorter oxygen treatment according to one embodiment. A relatively shorter exposure duration may result in a lower density film with a relatively higher amount of carbon. FIG. 3B is a schematic view of encapsulation catalyst nanoparticle system 140 with a relatively lower carbon thickness 160 on surface 162 of platinum catalyst nanoparticles 154 after a relatively longer oxygen treatment according to one embodiment. A relatively longer exposure duration may result in a higher density film with a relatively lower amount of carbon.

As shown in FIGS. 3A and 3B, silica forms as outer surface portions 156 and 166 of encapsulation catalyst nanoparticle systems 130 and 140, respectively. The density of the silica of outer surface portion 156 or outer surface 166 may be any of the following values or in a range of any two of the following values as a percentage of the standard density of silica of 2.65 g/cm³: 10%, 15%, 20%, 25%, 30%, 35%, 40%, 45%, 50%, 55%, 60%, 65%, 70%, 75%, and 80%. The silica outer surface portions are configured to resist catalyst poisoning with adsorbents such as carbon monoxide (CO) and/or sulphonic groups (SO₃⁻). The silica encapsulation resists undesirable reactions at the catalyst surface by acting as a physical barrier.

The silica encapsulation may have one or more of the following benefits: (a) chemical stability under an acidic environment, (b) inactivity as an electrocatalyst by itself for being electronically insulating, and/or (c) good permeability to many species relevant to electrochemical cell applications. The success of using silica may depend on the encapsulation thickness. In one or more embodiments, the thickness is thick enough to impart desirable selective transport properties but not so thick to create a large concentration of overpotential losses.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An electrochemical cell comprising:
first and second electrodes, the first electrode including first catalyst particles enhancing activity in the electrochemical cell, the second electrode including second catalyst particles enhancing activity in the electrochemical cell, one or both of the first and second catalyst particles at least partially encapsulated in a silica encapsulation formed from a precursor of a silicon-based copolymer, the silica encapsulation sustaining the activity of the first and/or second catalyst particles.

2. The electrochemical cell of claim 1, wherein the silicon-based copolymer is a silicon-carbon copolymer.

3. The electrochemical cell of claim 2, wherein the silicon-based copolymer has a low molecular weight in a range of 5,000 to 20,000 Daltons.

4. The electrochemical cell of claim 2, wherein the silicon-based copolymer includes silicon-based monomers and carbon-based monomers.

5. The electrochemical cell of claim 4, wherein the silicon-based monomers include monomer units including one or more siloxane groups, one or more carbosiloxane groups, one or more silane groups, one or more carbosilane groups, or a combination thereof.

6. The electrochemical cell of claim 4, wherein the carbon-based monomers include monomer units including one or more styrene groups, one or more ethylene groups, one or more propylene groups, or a combination thereof.

7. The electrochemical cell of claim 1, wherein the first and second catalyst particles are formed from first and second catalyst materials independently selected from pure Pt, a Pt-M alloy (where M is another metal from the periodic table), other platinum group members (PGM) metals (e.g., Ru, Rh, Pd, Os, and/or Ir), a PGM-M alloy (where M is another metal from the periodic table), a Pt-PGM-M alloy (where M is another metal from the periodic table), or a combination thereof.

8. The electrochemical cell of claim 1, wherein the silica encapsulation includes a silica network of SiO₂.

9. The electrochemical cell of claim 1, wherein the silica encapsulation includes a carbon film with silica forming on an outer surface portion of the silica encapsulation.

10. The electrochemical cell of claim 9, wherein the silica has a density of 0.265 g/cm³ to 2.12 g/cm³.

11. The electrochemical cell of claim 1, wherein one or both of the first and second catalyst particles are fully encapsulated in the silica encapsulation.

12. The electrochemical cell of claim 1, wherein the first and second catalyst particles are first and second catalyst nanoparticles.

13. An encapsulated catalyst particle system for an electrochemical cell comprising:
catalyst particles configured to enhance activity in the electrochemical cell; and
an encapsulation precursor of a silicon-based copolymer at least partially encapsulating the catalyst particles, the encapsulation precursor configured to sustain the activity of the catalyst particles.

14. The encapsulated catalyst particle system of claim 13, wherein the silicon-based copolymer is a silicon-carbon copolymer.

15. The encapsulated catalyst particle system of claim 14, wherein the silicon-based copolymer includes silicon-based monomers and carbon-based monomers.

16. The encapsulated catalyst particle system of claim 14, wherein the catalyst particles are formed from a catalyst material selected from pure Pt, a Pt-M alloy (where M is another metal from the periodic table), other platinum group members (PGM) metals (e.g., Ru, Rh, Pd, Os, and/or Ir), a PGM-M alloy (where M is another metal from the periodic table), a Pt-PGM-M alloy (where M is another metal from the periodic table), or a combination thereof.

17. A method of forming encapsulated catalyst particles for an electrochemical cell, the method comprising:
applying an encapsulation precursor of a silicon-based copolymer to catalyst particles, the catalyst particles configured to enhance activity in the electrochemical cell; and
subjecting the encapsulation precursor to an oxygen treatment to obtain the encapsulated catalyst particles including a silica encapsulation.

18. The method of claim 17, wherein the applying step includes dissolving the silicon-based copolymer in an organic solvent and adding the catalyst particles to the organic solvent.

19. The method of claim 17, further comprising annealing the encapsulation precursor before the subjecting step.

20. The method of claim 17, wherein the subjecting step is carried with ultraviolet (UV) exposure or oxygen plasma exposure.
